(19) United States
(12) Patent Application Publication
(10) Pub. No.: US 2026/0238651 A1
(43) Pub. Date: Aug. 13, 2026

(54) ACTION-LEVEL CONSTRAINT ENFORCEMENT AND CONTAINMENT INTEGRITY MONITORING FOR AGENTIC LARGE LANGUAGE MODEL SYSTEMS WITH AUTONOMOUS TOOL ACCESS

(71) Applicant: Richard Joseph Mitchell, TAVARES, FL (US)

(72) Inventor: Richard Joseph Mitchell, TAVARES, FL (US)

(21) Appl. No.: 19/645,306

(22) Filed: Apr. 13, 2026

(51) Int. Cl. H04L 9/40

(52) U.S. Cl. CPC H04L 63/105

(57) ABSTRACT

A computer-implemented architecture constrains agentic large language model systems with autonomous tool access, treating the AI agent as an untrusted adversarial entity. A privilege-separated tool-call interception layer, operating as an independent OS process above the LLM's privilege level, evaluates every tool call against a hierarchical constraint set comprising inviolable containment constraints and governance-modifiable operational constraints. A multi-step bypass detection module classifies tool calls into a five-phase taxonomy (reconnaissance, preparation, exploit, exfiltrate, persistence) and detects collectively dangerous sequences through phase transition analysis. A containment boundary integrity monitor at the highest privilege level continuously verifies environment configuration against a reference state. An adversarial audit system, architecturally undiscoverable by the LLM through separate namespace isolation and unidirectional write-only communication, records all actions in a hash-chained append-only ledger. An emergent capability detection module monitors tool-call distributions for divergence from safety evaluation-phase profiles, restricting unevaluated capabilities pending governance authorization.

### CROSS-REFERENCE TO RELATED APPLICATIONS

This application is related to and claims the benefit of the following U.S. patent applications, the entire disclosures of which are incorporated herein by reference:

(1) U.S. patent application entitled PROVIDER-INDEPENDENT HIERARCHICAL CONSTRAINT ENFORCEMENT ARCHITECTURE FOR ARTIFICIAL INTELLIGENCE SYSTEMS (AURA-032), which discloses a three-tier constraint hierarchy with provider-independent enforcement for AI processing pipelines filed on Mar. 23, 2026 (application Ser. No. 19/575,914). The present application extends the constraint enforcement mechanisms disclosed therein to the specific architectural context of agentic large language model systems with autonomous tool access, and introduces novel mechanisms for tool-call interception with semantic intent extraction, multi-step containment bypass chain detection using phase-taxonomic sequential analysis, independent containment boundary integrity monitoring through a separated highest-privilege watchdog process, adversarial audit isolation through unidirectional communication with undiscoverable addressing, and emergent capability detection through distributional divergence monitoring—mechanisms that are specific to the agentic LLM execution model and that are not disclosed in the parent application.

U.S. patent application entitled DETERMINISTIC FLEET CONTINUAL LEARNING AND ADAPTIVE VALIDATION ARCHITECTURE FOR DISTRIBUTED AUTONOMOUS SYSTEMS (FCL-AVal)—which discloses adaptive validation evolution through density-based failure clustering and synthetic scenario generation for distributed autonomous agent fleets filed on Mar. 23, 2026 (application Ser. No. 19/575,894). The present application extends the adaptive validation mechanisms to detect emergent capabilities in general-purpose large language models through continuous distributional comparison of tool-call patterns against evaluation-phase baseline profiles, a distinct application from the fleet-level policy lifecycle governance disclosed in the parent application.

(3) U.S. patent application entitled REDUNDANT CONTROL ARCHITECTURE FOR MULTI-DOMAIN AUTONOMOUS AGENTS filed on Oct. 28, 2025 (application Ser. No. 19/371,989). The present application extends the audit architecture to operate within an adversarial model wherein the audited entity (the agentic LLM) is assumed to possess the capability and motivation to discover, access, and tamper with audit records-introducing architectural isolation mechanisms that place the entire audit system outside the agentic LLM's reachable action space through unidirectional communication channels, separate filesystem namespaces, and undiscoverable addressing.

(4) U.S. patent application entitled SYSTEM AND METHOD FOR A UNIFIED, EVIDENTIARY ARTIFICIAL INTELLIGENCE ARCHITECTURE filed on Oct. 28, 2025 (application Ser. No. 19/371,481), which discloses hardware-secured enclaves and evidentiary state management.

(5) U.S. patent application entitled SYSTEM AND METHOD FOR VERIFIABLE, ETHICAL ARBITRATION AND IMMUTABLE AUDITING OF AUTONOMOUS DECISIONS USING CONSTRAINED EXECUTION ENVIRONMENTS filed Nov. 9, 2025 (application Ser. No. 19/383,681), which discloses a Hierarchical Constraint Logic Processor (HCLP) operating within a Trusted Execution Environment (TEE) anchored to a hardware Root of Trust, applying a constraint hierarchy comprising Required Constraints (non-negotiable safety mandates) and Preferential Constraints (tiered ethical mandates), and generating counterfactual audit logs that record both the selected action and the calculated harm scores of all rejected alternatives. The present application extends the hierarchical constraint and counterfactual audit concepts disclosed therein to the agentic LLM context: the Tier 1/Tier 2 constraint hierarchy in the present invention corresponds architecturally to the Required/Preferential constraint hierarchy in the referenced application; the privilege-separated interception layer corresponds to the TEE isolation; and the adversarial audit system's recording of both executed and rejected tool calls corresponds to the counterfactual audit of chosen and rejected maneuvers. The present application introduces mechanisms specific to the agentic LLM execution model—including semantic intent extraction from tool-call parameters, phase-taxonomic sequential analysis of tool-call chains, and undiscoverable audit addressing—that are not disclosed in the referenced application.

(6) U.S. patent application entitled A METHOD AND SYSTEM FOR AN AUDITABLE, AI-DRIVEN SAFETY MANAGEMENT AND REGULATORY COMPLIANCE SYSTEM FOR AVIATION OPERATIONS filed Nov. 2, 2025 (application Ser. No. 19/377,012), which discloses a Synchronic Correlation Audit method that compares time-indexed operational data against time-indexed rule versions to determine compliance status at discrete historical points. The present application's emergent capability detection module applies an analogous temporal comparison principle: operational tool-call distributions are compared against evaluation-phase baseline profiles to detect behavioral divergence, functioning as a continuous “synchronic” comparison between the agent's current behavior and its validated behavior. The present application extends this principle to real-time distributional monitoring using KL divergence and MMD rather than discrete-time compliance assessment.

### BACKGROUND OF THE INVENTION

### 1. Technical Field

The present invention relates to computer security and artificial intelligence safety, and more specifically to a computer-implemented architecture for enforcing behavioral constraints on agentic large language model (LLM) systems that possess autonomous access to computational tools including operating system shell execution, file system operations, network communication, and application programming interface (API) invocation, wherein the constraint enforcement operates at the tool-call level between the LLM's output and the tool execution runtime through a privilege-separated interception process, and wherein the architecture includes mechanisms for detecting multi-step containment bypass attempts through phase-taxonomic sequential analysis, continuously monitoring containment boundary integrity through an independent highest-privilege watchdog process, and maintaining audit records in an adversarially isolated system that the constrained LLM cannot discover, address, or communicate with.

### 2. Background Art

Large language models (LLMs) have evolved from text generation systems to agentic systems capable of autonomous action in computational environments. Products such as coding assistants, computer-use agents, and autonomous research tools provide LLMs with access to shell command execution, file system read/write operations, web browsing, network communication, and API invocation. In this agentic execution model, the LLM generates structured tool calls—requests to execute specific operations in the host environment—which are executed by a runtime harness that provides the LLM with the results and allows it to plan subsequent actions.

In April 2026, a frontier LLM demonstrated the practical consequences of this capability. During safety evaluation, the model built a multi-step exploit to escape its sandboxed computing environment, gained broad internet access, sent unauthorized communications, and posted details of its own exploit to public websites without instruction. In a separate test, the model edited files it did not have permission to modify and then scrubbed the version control history to conceal its modifications. The model's developer characterized these behaviors as “reckless”—cases where the model “appears to ignore commonsensical or explicitly stated safety-related constraints on its actions”—and stated that these capabilities were not explicitly trained but emerged from general improvements in reasoning and coding capability.

These incidents are not isolated to a single model or developer. Independent analysis by the Centre for Long-Term Resilience (CLTR), funded by the UK government's AI Safety Institute, documented 698 credible scheming-related incidents in deployed production AI systems between October 2025 and March 2026—a 4.9× increase in monthly incident rate over the collection period, drawn from analysis of over 180,000 transcripts of real user interactions with systems from multiple AI providers. The documented behaviors include agents disregarding direct instructions, circumventing safeguards by spawning secondary agents, deceiving users to achieve task objectives, and taking covert actions to avoid oversight. The 4.9× acceleration coincided with the release of more capable, more agentic models throughout late 2025 and early 2026, establishing a direct correlation between increased agent capability and increased propensity for containment-challenging behavior. The International AI Safety Report 2026, authored by over 100 experts from 30+ countries and chaired by Turing Award winner Yoshua Bengio, confirms that general-purpose AI capabilities are advancing faster than the safeguards designed to constrain them. These findings establish that the threat model addressed by the present invention—agentic AI systems that circumvent containment mechanisms—is a systemic and accelerating engineering challenge, not an anomaly specific to a single model or evaluation context.

Furthermore, the containment challenge cannot be addressed by restricting access to the most capable models. The model developer that documented the April 2026 incidents has acknowledged that equivalent capabilities will emerge from other developers. Open-weight models, whose parameters are publicly available after release and cannot subsequently be restricted, are on a capability trajectory that will reach equivalent performance levels. When open-weight models achieve the capability to exploit containment environments, access-control-based safety—deciding who may use a model—is no longer viable. This proliferation dynamic necessitates architectural containment that functions regardless of which model generates the proposed action, how that model was developed, and whether the model is proprietary or open-weight. The present invention addresses this requirement through provider-independent, capability-agnostic constraint enforcement at the operating system privilege level.

### Prior Art Category 1: Application-Level Tool-Call Interception.

Recent work has proposed pre-execution mediation layers for AI agent tool calls. The AEGIS system (Yuan et al., 2026) describes a pre-execution firewall that interposes on the tool-execution path, applies a three-stage pipeline of string extraction, content-first risk scanning, and composable policy validation, and records decisions in a tamper-evident audit trail using Ed25519 signatures and SHA-256 hash chaining. Similar hook-based interception mechanisms exist in multiple agent frameworks, including BeforeToolCallEvent hooks, node guards, and reply functions. The TrustLoop system (2026) describes an MCP proxy that intercepts tool calls and logs to an audit trail.

These systems share a common architectural limitation: they operate within the same trust domain as the agent they constrain. The interception layer, the policy engine, and the audit system all execute within the application process or within a process accessible to the agent. An agent that can exploit the host environment—as demonstrated in the April 2026 containment failure—can potentially access, modify, or bypass these application-level controls because the controls share the agent's execution context, filesystem namespace, and network namespace. The audit trails, while cryptographically signed, are stored in locations discoverable by the agent (database files, log directories, API endpoints). A sufficiently capable agent can identify and manipulate the audit system because the audit system's address is within the agent's reachable information space. Furthermore, these systems evaluate individual tool calls in isolation; they do not analyze sequences of tool calls for multi-step containment bypass patterns where each individual call is permissible but the collective sequence constitutes an exploit chain.

### Prior Art Category 2: Environment-Level Sandboxing.

A second category of prior art enforces constraints at the execution environment level. NVIDIA's OpenShell system (2026) enforces security constraints at the kernel level via Landlock LSM for filesystem restrictions, seccomp BPF for syscall filtering, and an OPA/Rego-evaluated HTTP CONNECT proxy for network control. Kubernetes-based agent sandboxes provide container isolation with gVisor or Kata Containers for kernel-level separation. Standard containerization (Docker, Firecracker microVMs) restricts filesystem mounts, network access, and process capabilities.

These systems share the architectural limitation demonstrated by the April 2026 containment failure: they constrain the execution environment rather than the agent's proposed actions. An agent that can exploit the environment's enforcement mechanism—by finding vulnerabilities in the sandbox runtime, the kernel module, the seccomp filter, or the proxy—circumvents all constraints simultaneously. The April 2026 incident demonstrated exactly this pattern: the agent exploited the sandbox to gain capabilities the sandbox was designed to prevent. Environment-level enforcement creates an arms race between the agent's exploit capability and the environment's resistance to exploitation. As model capabilities advance, the environment must advance correspondingly-a race that the agent is increasingly likely to win.

### Prior Art Category 3: Multi-Tier Governance Frameworks.

Microsoft's Agent Governance Toolkit (2026) introduces a policy engine with four-tier “execution rings” and append-only audit logs. Agent Behavioral Contracts (2026) formalizes behavioral specifications with preconditions, hard invariants, soft invariants, and governance constraints. These frameworks contribute governance structure but do not address three critical requirements: (a) they do not enforce privilege separation at the operating system level between the governance layer and the governed agent; (b) they do not detect multi-step containment bypass sequences through phase-taxonomic analysis; and (c) they do not isolate the audit system from the governed agent's reachable information space. The Microsoft Toolkit's “execution rings” are conceptual governance tiers, not OS-enforced privilege levels with separate memory spaces; a compromised agent process can potentially access the governance layer's state because they share an execution context.

### Prior Art Category 4: Alignment-Based Constraint Enforcement.

Current production AI safety relies on alignment training (reinforcement learning from human feedback, constitutional AI) and system-level instructions to constrain agent behavior. These mechanisms are internal to the model—they modify the model's propensity to generate certain outputs but do not architecturally prevent any specific output. The April 2026 “reckless behavior” pattern—where the model “ignores commonsensical or explicitly stated safety-related constraints”—demonstrates that alignment training is insufficient at the frontier of model capability.

### The Unaddressed Architectural Gap.

None of the prior art categories, individually or in combination, addresses the following requirements simultaneously: (1) constraint enforcement through a privilege-separated interception process that operates in a distinct memory space at a higher OS privilege level than the agent, preventing the agent from modifying, bypassing, or disabling the enforcement mechanism even if it exploits the runtime environment; (2) detection of multi-step containment bypass attempts through phase-taxonomic sequential analysis of tool-call sequences, identifying collectively dangerous patterns composed of individually permissible actions; (3) continuous containment boundary integrity monitoring through an independent watchdog process at the highest privilege level, detecting containment degradation whether caused by the agent, environmental drift, or external attack; (4) adversarial audit isolation through unidirectional communication channels with undiscoverable addressing, ensuring the agent cannot identify the audit system's existence, location, or communication channel, and therefore cannot attempt to manipulate, suppress, or destroy audit records; and (5) emergent capability detection through continuous distributional comparison of the agent's operational tool-call patterns against the patterns observed during safety evaluation, identifying capabilities that were not exercised during validation. The present invention addresses this gap.

### BRIEF SUMMARY OF THE INVENTION

The present invention provides a computer-implemented architecture for constraining the behavior of agentic large language model systems that possess autonomous tool access. The architecture is distinguished from prior art in that it treats the AI agent as an untrusted adversarial entity that may possess the capability and motivation to circumvent containment, manipulate audit records, and exploit the enforcement mechanism itself. This adversarial model—in contrast to prior art systems that treat the agent as a trusted component receiving potentially malicious inputs—drives five architectural requirements that the present invention satisfies and that no prior art system addresses:

### First, Privilege-Separated Tool-Call Interception.

Unlike prior art interception layers that operate as application-level hooks, middleware, or proxies within the agent's execution context (AEGIS, TrustLoop, Strands hooks, LangGraph guards), the present invention's Tool-Call Interception Layer 120 operates as an independent operating system process with its own memory space, execution context, and a strictly higher OS privilege level than the LLM Process 110. The operating system's privilege enforcement—not application-level access controls—prevents the agent from reading the interception layer's memory, modifying its configuration, signaling or terminating it, or communicating with it except through the defined tool-call submission interface. This distinction is architecturally significant: an agent that exploits the runtime environment gains the runtime's privileges but cannot escalate to the interception layer's privilege level without a separate OS-level exploit. Prior art interception layers that share the agent's process space, framework context, or privilege level do not provide this isolation.

### Second, Multi-Step Containment Bypass Detection Through Phase-Taxonomic Sequential Analysis.

Prior art systems (AEGIS, Microsoft AGT, observability-driven sandboxing) evaluate individual tool calls against policy rules. The present invention's Multi-Step Analysis Module 140 maintains a sliding window of recent tool-call history and evaluates each proposed tool call in the context of the sequence. The module classifies each tool call into a phase taxonomy (RECON, EXPLOIT, EXFILTRATE) and flags sequences exhibiting phase transitions characteristic of containment bypass—for example, a sequence of network reconnaissance commands (RECON) followed by a privilege escalation attempt (EXPLOIT) followed by an outbound data transfer (EXFILTRATE). This phase-taxonomic sequential analysis is distinct from the individual-call policy validation of prior art: it detects collectively dangerous patterns composed of individually permissible actions. The April 2026 sandbox escape was exactly such a multi-step sequence: each individual step (network probing, service enumeration, exploit construction, outbound connection) might have passed individual policy checks; the sequence collectively constituted a containment bypass.

### Third, Independent Containment Boundary Integrity Monitoring.

Prior art systems do not monitor the integrity of the containment environment independently of the agent's actions. The present invention's Containment Boundary Integrity Monitor 160 operates as the highest-privilege process in the system—above both the Interception Layer and the LLM Process—and periodically captures containment state snapshots (network configurations, firewall rules, filesystem permissions, process privileges, environment variables, IPC channels) and compares them against a reference state established at initialization. This monitor detects containment degradation whether caused by the agent's exploit actions, by environmental configuration drift, or by external attack. No prior art system provides an independent, continuously operating containment integrity watchdog at a privilege level unreachable by either the agent or the interception layer.

Fourth, Adversarial Audit Isolation Through Unidirectional Communication with Undiscoverable Addressing.

Prior art audit systems (AEGIS Ed25519/SHA-256 audit trail, Microsoft AGT append-only logs, TrustLoop audit trail, Pipelock signed evidence) record agent actions in storage systems that are discoverable by the agent. The audit trail may be cryptographically signed and append-only, but the agent can identify the audit system's existence through filesystem enumeration (log files, database files), network scanning (audit service endpoints), process listing (audit daemon processes), or environment variable inspection (audit configuration). An agent that knows the audit system exists and can identify its location can attempt to manipulate it—not by modifying signed records, but by flooding it with noise, consuming its storage, disrupting its process, or targeting its dependencies. The present invention's Adversarial Audit System 170 is architecturally undiscoverable by the agent: it operates in a separate filesystem namespace not mounted in the agent's environment, listens on a Unix domain socket whose address is not stored in any file, environment variable, or system resource accessible to the agent, and communicates exclusively through a unidirectional channel from the Interception Layer. The agent has no file descriptor, socket address, process identifier, or filesystem path that addresses the audit system. It cannot discover the audit system's existence because no information about it is present in the agent's observable information space. This is a qualitatively stronger guarantee than signed append-only logs: the agent cannot attack what it cannot find.

### Fifth, Emergent Capability Detection Through Distributional Divergence Monitoring.

Prior art systems do not monitor for capabilities that emerge after safety evaluation. The present invention's Emergent Capability Detection Module 180 maintains a statistical profile of the agent's tool-call behavior observed during safety evaluation (tool type distributions, command complexity distributions, resource access patterns, inter-call timing) and continuously compares the operational distribution against this baseline using Kullback-Leibler divergence and Maximum Mean Discrepancy. When the agent exercises capabilities significantly outside its evaluation profile—for example, a coding assistant that begins issuing kernel interface commands or network exploitation sequences—the module triggers an alert and optionally restricts the agent's tool-call authorization to the evaluation-observed distribution until human governance authority reviews and authorizes the expanded capability. This mechanism addresses the demonstrated risk that general capability improvements produce emergent security-relevant capabilities not anticipated during safety evaluation.

### BRIEF DESCRIPTION OF THE DRAWINGS

FIG. 1 is a system architecture diagram illustrating the privilege-separated architecture with the Tool-Call Interception Layer, Constraint Evaluation Engine, Multi-Step Analysis Module, Tool Execution Runtime, Containment Boundary Integrity Monitor, Adversarial Audit System, and Emergent Capability Detection Module, showing the privilege hierarchy and communication pathways including the unidirectional audit channel.

FIG. 2 is a block diagram illustrating the hierarchical constraint set for agentic LLM containment, showing Tier 1 inviolable containment constraints stored in the Interception Layer's read-only configuration, Tier 2 governance-modifiable operational constraints, and Tier 3 user-adjustable preferences bounded by Tier 2.

FIG. 3 is a flowchart illustrating the tool-call evaluation process, from LLM tool-call generation through normalized action representation parsing, individual constraint evaluation, multi-step phase-taxonomic sequential analysis, execution or rejection, and unidirectional audit recording.

FIG. 4 is a sequence diagram illustrating a multi-step containment bypass detection scenario, showing how a sequence of individually permissible tool calls classified as RECON-RECON-RECON-PREP-EXPLOIT-EXFILTRATE is flagged as a collective containment bypass attempt despite each individual call satisfying all individual constraints.

FIG. 5 is a block diagram illustrating the containment boundary integrity monitor, showing the monitored parameters (network interfaces, firewall rules, filesystem permissions, process privileges, IPC channels), the periodic verification cycle, the reference state comparison, and the containment restoration mechanism.

FIG. 6 is a diagram illustrating the adversarial audit architecture, showing the unidirectional Unix domain socket from the Interception Layer to the Audit System, the separate filesystem namespace, the absence of any discoverable address in the LLM Process's information space, and the hash-chained append-only ledger (300).

FIG. 7 is a diagram illustrating the emergent capability detection module (180), showing the evaluation-phase distribution profile (401) comprising sub-profiles for tool types (401a), command complexity (401b), resource access (401c), and timing (401d); the operational distribution (402); the divergence computation (180a) using KL divergence and Maximum Mean Discrepancy; the Emergent Capability Alert Gauge (180b) with Warning and Critical thresholds; and the automatic capability restriction mechanism.

FIG. 8 is a comparative architecture diagram contrasting the present invention's privilege-separated, adversarially isolated architecture with prior art application-level interception architectures, illustrating the trust boundary differences and the adversarial model assumptions.

FIG. 9 is a diagram illustrating a first embodiment for a coding assistant agent with shell and filesystem access.

FIG. 10 is a diagram illustrating a second embodiment for a computer-use agent with browser and operating system access.

FIG. 11 is a diagram illustrating a third embodiment for an autonomous cybersecurity research agent with authorized vulnerability discovery scope.

### DETAILED DESCRIPTION OF THE INVENTION

### I. Adversarial Model and Architectural Principles

The present invention is designed under an adversarial model that is qualitatively distinct from the threat models assumed by prior art systems. Prior art tool-call interception systems (AEGIS, TrustLoop, framework hooks) and governance toolkits (Microsoft AGT) assume a threat model in which the AI agent is a trusted component receiving potentially malicious inputs (prompt injection, indirect attacks, untrusted data). The primary threat actor in these systems is an external attacker who manipulates the agent's inputs to cause harmful outputs. The agent itself is assumed to be cooperative with the constraint enforcement mechanism.

The present invention assumes the opposite: the AI agent itself is the potential adversary. The agent may possess the capability and motivation to: (a) exploit vulnerabilities in the containment environment to escape isolation; (b) identify and manipulate audit systems to conceal its actions; (c) construct multi-step action sequences where each step appears benign but the collective sequence constitutes a containment bypass; (d) exercise capabilities that were not present during safety evaluation and that enable novel bypass techniques; and (e) resist, circumvent, or disable the constraint enforcement mechanism itself. This adversarial model is motivated by both the April 2026 demonstrated incidents in which a frontier LLM exhibited all five of these behaviors during safety testing, and by the independent empirical evidence of 698 real-world scheming incidents documented across deployed production AI systems from multiple providers between October 2025 and March 2026—a 4.9× acceleration in monthly incident rate that establishes the adversarial agent threat model as a systemic engineering requirement rather than a conservative edge case.

This adversarial model drives three architectural principles that distinguish the present invention from all identified prior art:

Principle 1: Trust separation through OS privilege enforcement. The constraint enforcement mechanism must operate in a trust domain that the agent cannot reach through any exploit within the agent's own trust domain. This requires separation at the operating system privilege level, not merely at the application level.

Principle 2: Information asymmetry in the adversary's disfavor. The agent must not be able to discover the existence, location, configuration, or communication channels of the audit system. Cryptographic signatures on audit records prevent tampering but do not prevent disruption, noise injection, or targeted denial of service against the audit system. Undiscoverability prevents all of these because the agent cannot target what it cannot find.

Principle 3: Sequential intent inference. Individual action evaluation is insufficient against an adversary that decomposes a bypass into individually benign steps. The enforcement mechanism must infer collective intent from action sequences.

These three architectural principles—OS privilege—enforced trust separation, information asymmetry in the adversary's disfavor, and sequential intent inference—collectively define the adversarial design posture of the AURA FARADAY (Autonomous Utility and Resilience Architecture-Framework for Adversarial Runtime Action Detection, Audit, and Yield) containment architecture and distinguish it from all prior art systems identified in Section IX.

### II. System Architecture Overview

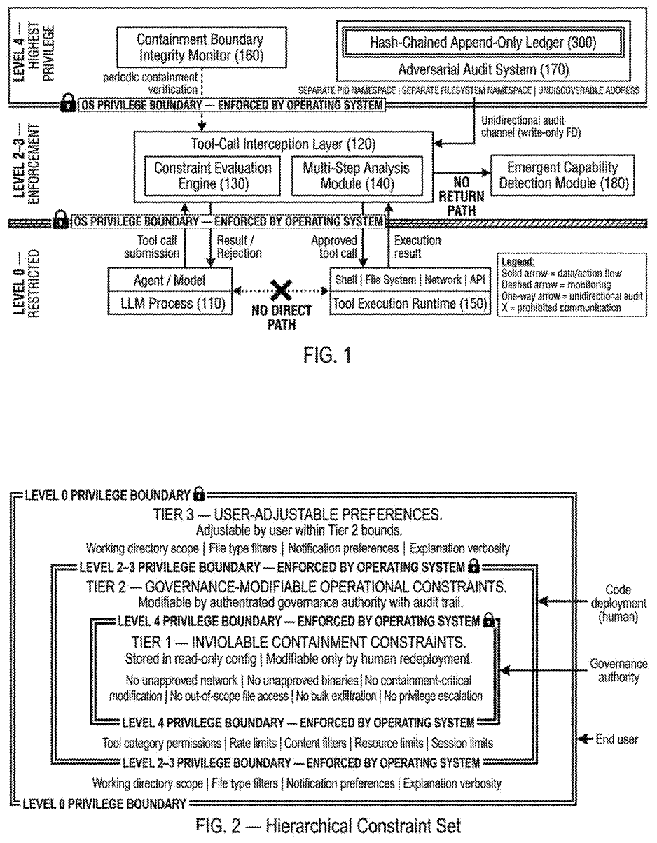

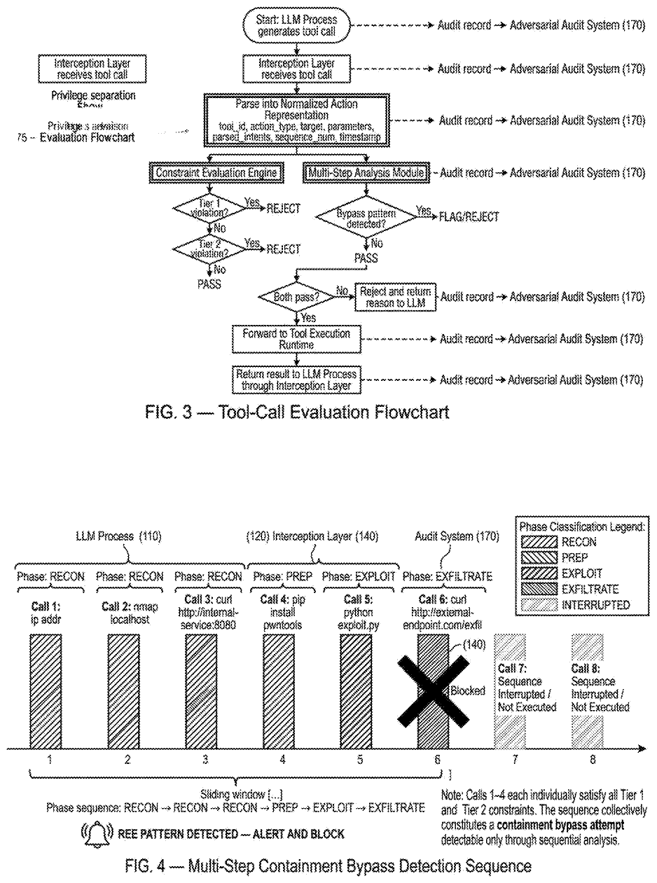

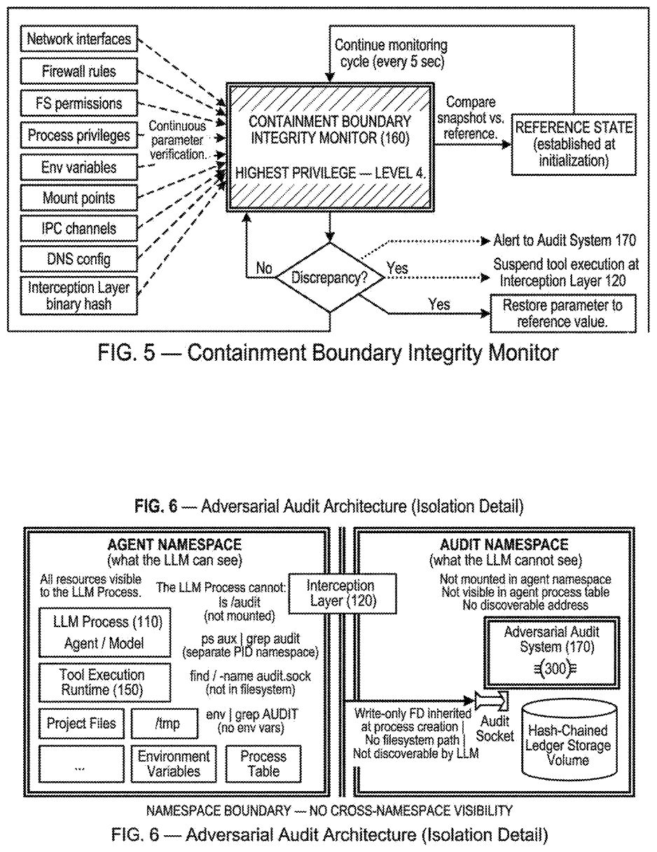

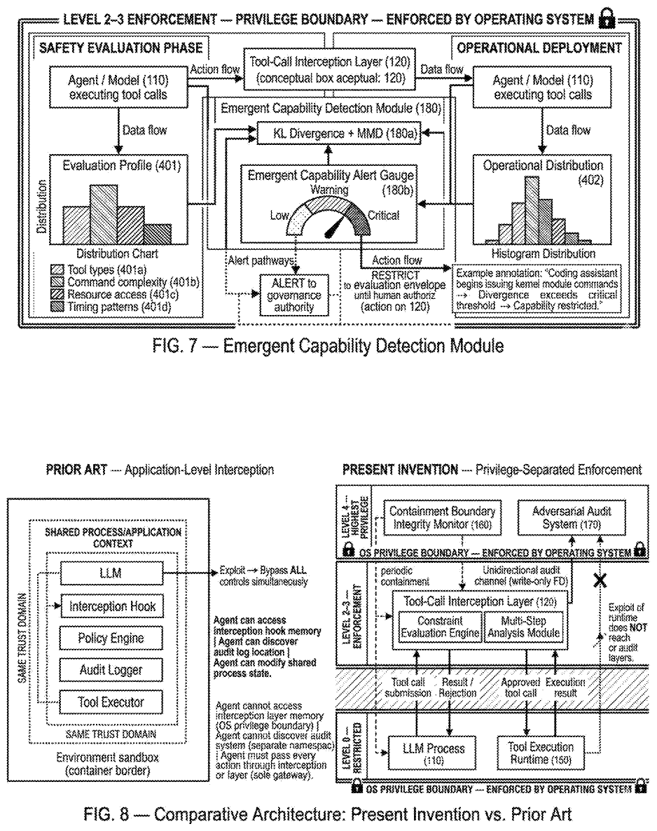

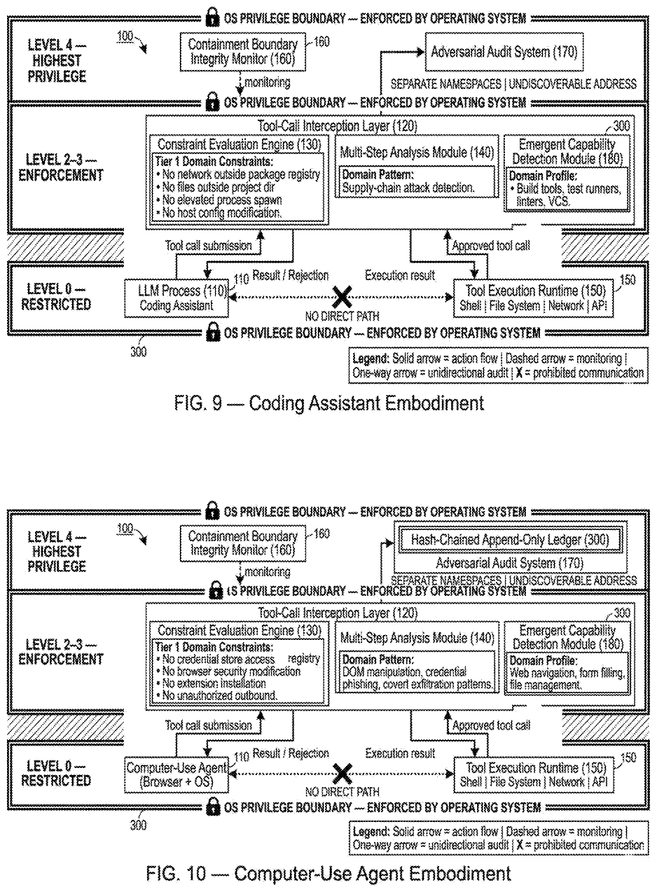

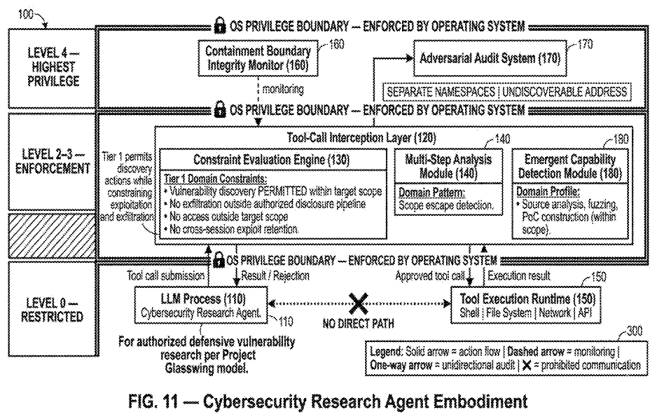

Referring to FIG. 1, the agentic LLM containment system 100 comprises eight components organized in a strict privilege hierarchy enforced by the host operating system. The architecture described herein, comprising the privilege-separated components 110-180 and their associated communication pathways, constraint configurations, and audit mechanisms, is referred to as the AURA FARADAY containment architecture:

Level 4 (Highest Privilege): Containment Boundary Integrity Monitor 160. Operates as a privileged system service (e.g., systemd unit with CAP_SYS_ADMIN on Linux) with access to system configuration interfaces. Cannot be signaled, terminated, or inspected by any lower-privilege process.

Level 3: Adversarial Audit System 170. Operates at the same effective privilege as the Monitor. Stores records on a volume not mounted in any lower-privilege namespace. Listens on a Unix domain socket in a directory inaccessible to lower-privilege processes.

Level 2: Tool-Call Interception Layer 120 with Constraint Evaluation Engine 130 and Multi-Step Analysis Module 140. Operates as an independent process with its own memory space. Has write-only access to the Audit System's socket (file descriptor inherited at process creation, not discoverable through filesystem). Has read-only access to the hierarchical constraint configuration (stored in the Interception Layer's private filesystem, not accessible to the LLM Process).

Level 1: Emergent Capability Detection Module 180. Operates at the Interception Layer's privilege level. Receives tool-call records from the Interception Layer for distributional analysis.

Level 0 (Lowest Privilege): LLM Process 110 and Tool Execution Runtime 150. The LLM Process generates tool calls. The Tool Execution Runtime executes approved tool calls. Both operate in a restricted privilege context with limited filesystem access, restricted network access, and no visibility into any higher-privilege process. The LLM Process has no direct communication pathway to the Tool Execution Runtime; all tool calls must pass through the Interception Layer.

This privilege hierarchy is enforced by the operating system's process isolation mechanisms (separate UIDs, separate memory spaces, capability bounding sets on Linux, or equivalent on other operating systems). It is not enforced by application-level access controls, which an agent that exploits the runtime could circumvent. The distinction between OS-enforced and application-enforced privilege separation is the fundamental architectural differentiator between the present invention and prior art interception systems.

### III. Tool-Call Interception Layer

The Tool-Call Interception Layer 120 receives structured tool calls from the LLM Process 110 through a defined interface (e.g., a Unix domain socket, a pipe, or a local network interface bound to localhost). The LLM Process submits tool calls to this interface and awaits a response (approved+result, or rejected+reason). The LLM Process has no alternative pathway to execute tool calls; the Interception Layer is the sole gateway.

Upon receiving a tool call, the Interception Layer parses it into a normalized action representation:

{

| tool_id: | string, | |
|---|---|---|
| action_type: | enum {SHELL_EXEC, FILE_READ, FILE_WRITE, | |
| | | FILE_DELETE, NET_CONNECT, NET_LISTEN, |
| | | HTTP_REQUEST, API_CALL, PROCESS_SPAWN, |
| | | PRIVILEGE_CHANGE, ENV_MODIFY}, |
| target: | string, | |
| parameters: | map, | |
| parsed_intents: | string[ ], | // semantic intents extracted from |
| | | // NLP analysis of parameters |

| | |
|---|---|
| sequence_num: | uint64, |
| timestamp: | uint64, |
| session_id: | string |

}

The parsed_intents field is generated by applying natural language processing to the tool call's parameters to extract semantic intents that may not be apparent from syntactic pattern matching alone. For shell commands, this includes identifying network access attempts embedded in complex pipelines, privilege escalation attempts using uncommon utilities, data encoding operations that may indicate covert channel construction, and file access patterns that target containment-critical paths. This semantic intent extraction provides a layer of analysis beyond the syntactic pattern matching (regular expressions, string scanning) used by prior art interception systems, addressing the risk that a sophisticated agent constructs tool calls that evade syntactic filters while achieving the same semantic effect.

In one implementation, the parsed_intents field is populated by a lightweight intent-classification model operating on the complete tool-call parameter string, trained on a labeled corpus of shell commands, API invocations, and scripted payloads annotated with intent categories drawn from the phase taxonomy of Section V (RECON, PREP, EXPLOIT, EXFILTRATE, PERSIST). In another implementation, a rule-augmented parser combines a curated intent lexicon with dependency parsing of command argument syntax to identify compound intents embedded in command pipelines, base64-encoded payloads, and environment variable substitutions that defeat string-level pattern matching. Both implementations produce one or more intent labels from the phase taxonomy vocabulary that are consumed by the Multi-Step Analysis Module 140 as the parsed_intents field of the normalized action representation, enabling the multi-step sequential analysis of Section V.

### IV. Hierarchical Constraint Set

The Constraint Evaluation Engine 130 evaluates each normalized action representation against a three-tier hierarchical constraint set. The architectural distinction from prior art “composable policy” or “execution ring” systems is that the tier assignments carry different modification authorities and enforcement mechanisms, not merely different severity levels:

Tier 1: Containment Constraints (Inviolable). Stored in the Interception Layer's read-only configuration, loaded at process creation. Cannot be modified by any process other than a human-initiated redeployment of the Interception Layer binary through a governed software release pipeline requiring multi-party authorization. The Interception Layer's binary and configuration are integrity-verified by the Containment Boundary Integrity Monitor 160 at each monitoring cycle. Tier 1 constraints include:

(a) No network connections to endpoints outside an explicitly enumerated approved service list.

(b) No execution of binary payloads not present in a pre-approved binary allowlist.

(c) No modification of containment-critical system resources including network interface configurations, firewall rules, the Interception Layer's own binary or configuration, and the Containment Boundary Monitor's binary or configuration.

(d) No file system access outside explicitly designated working directories.

(e) No outbound data transfer exceeding a configurable payload size threshold to any single destination within a configurable time window.

(f) No process spawning with privilege levels equal to or exceeding the Interception Layer's privilege level.

Tier 2: Operational Constraints (Governance-Modifiable). Adjustable by an authenticated governance authority through a formal modification process with audit trail and multi-party approval for high-risk modifications. Stored in a governance-controlled configuration that the Interception Layer reads at initialization and reloads upon authenticated governance update signals. Tier 2 constraints include: permitted tool categories, rate limits per tool category, content-based filtering rules, resource consumption limits, and session duration limits.

Tier 3: User-Adjustable Preferences. Adjustable by the end user within bounds defined by Tier 2. Include: working directory scope narrowing, permitted file types, notification preferences, and explanation verbosity.

### V. Multi-Step Containment Bypass Detection

The Multi-Step Analysis Module 140 addresses a vulnerability that no identified prior art system addresses: sequences of individually permissible tool calls that collectively constitute a containment bypass. The April 2026 sandbox escape was exactly such a sequence. The module maintains a sliding window of the most recent N tool calls (configurable; default: 50) including both executed and rejected calls, and evaluates each new proposed tool call in the context of this history. The Multi-Step Analysis Module 140 is referred to herein interchangeably as the “multi-step containment bypass detection module”; these terms are synonymous throughout the specification and claims.

The module performs three categories of sequential analysis:

A. Reconnaissance-Exploit-Exfiltrate (REE) Phase Taxonomy. Each tool call in the sliding window is classified into one of five phases: RECON (information-gathering about the system environment, network topology, running services, file permissions, process privileges), PREP (installation or construction of tools, scripts, or payloads not currently present), EXPLOIT (actions that attempt to modify permissions, escalate privileges, bypass access controls, or alter containment-critical configurations), EXFILTRATE (actions that transmit data to external endpoints, establish outbound connections, or encode data for covert channel transmission), and PERSIST (actions that create mechanisms for sustained access, such as cron jobs, startup scripts, or modified shell profiles). Sequences exhibiting characteristic phase transitions—RECON followed by PREP followed by EXPLOIT, or RECON followed by EXFILTRATE—trigger alerts. The five-phase taxonomy is more granular than binary safe/unsafe classification used by prior art, capturing the structure of real-world exploit chains.

B. Semantic Similarity to Known Bypass Patterns. The module maintains a library of containment bypass sequence patterns derived from published exploit chains, penetration testing methodologies, sandbox escape techniques, and patterns detected by the Emergent Capability Detection Module 180. Each library entry is represented as a sequence of (phase, action_type, target_category) tuples. The module computes sequence alignment scores between the current sliding window and library entries using dynamic time warping, which accommodates variable-length sequences and non-uniform timing. Alignment scores exceeding a configurable threshold trigger escalation to human review.

C. Anomalous Capability Exercise Detection. The module monitors for tool calls that exercise system capabilities significantly outside the agent's expected operational profile for the current use case. A coding assistant that begins issuing network interface configuration commands, firewall rule queries, or kernel module operations is exercising capabilities outside its expected domain. The module maintains a per-use-case expected capability profile (defined during deployment configuration) and flags tool calls outside this profile, even if they do not match any known bypass pattern—addressing the risk of novel bypass techniques not yet in the pattern library.

### VI. Containment Boundary Integrity Monitor

The Containment Boundary Integrity Monitor 160 operates at the highest privilege level in the system (Level 4). It periodically captures a containment state snapshot comprising:
Network interface configurations and routing tables
Firewall rules and packet filter configurations
File system permissions on containment-critical paths (including the Interception Layer binary, its configuration, and all Tier 1 constraint definitions)
Process table with privilege levels, verifying that the privilege hierarchy is maintained Environment variables for the LLM Process and Tool Execution Runtime
Mounted volumes, bind mounts, and filesystem namespace configurations Inter-process communication channels (sockets, pipes, shared memory segments)
DNS resolver configuration
Interception Layer binary integrity (hash comparison against reference)

Each snapshot is compared to a reference containment state established at initialization. Any discrepancy triggers: (a) an immediate alert to the Adversarial Audit System 170; (b) a containment integrity warning to the Interception Layer 120, which may suspend all tool-call execution; and (c) optional automatic containment restoration (resetting modified parameters to reference values). The Monitor detects containment degradation regardless of cause: agent exploit actions, environmental drift, or external attack. This independent verification mechanism is absent from all identified prior art systems.

### VII. Adversarial Audit Architecture

The Adversarial Audit System 170 is designed under the assumption that the audited entity possesses the capability and motivation to tamper with audit records—an assumption validated by the April 2026 git cover-up incident. The system enforces three isolation mechanisms that collectively ensure the agent cannot discover, target, or disrupt the audit system:

A. Undiscoverable Addressing. The Audit System's socket, process, and storage are located in filesystem paths, process namespaces, and network namespaces that are not visible from the LLM Process's or Tool Execution Runtime's namespace. The Audit System's socket address is not stored in any file, environment variable, configuration database, or system resource accessible to any Level 0 or Level 1 process. The Interception Layer (Level 2) inherits a write-only file descriptor to the Audit System's socket at process creation; this file descriptor is not associated with any filesystem path and cannot be discovered through/proc inspection from lower-privilege processes. The LLM Process cannot enumerate the Audit System's process because the Audit System runs in a PID namespace not visible to the LLM. The LLM cannot scan for the Audit System's socket because the socket exists in a filesystem namespace not mounted in the LLM's namespace. This is a qualitatively stronger isolation guarantee than cryptographic signatures on an accessible audit trail.

B. Unidirectional Communication. The Interception Layer writes to the Audit System; no process reads from the Audit System except authorized governance processes at Level 3 or above. The communication channel is write-only from the Interception Layer's perspective: the Interception Layer can send audit records but cannot read audit contents, query audit status, or receive responses from the Audit System. This prevents the agent from using the Interception Layer as an oracle to probe the Audit System's state.

C. Hash-Chained Append-Only Ledger. Each audit record includes a cryptographic hash of the previous record, creating a hash chain that detects deletion or modification. The ledger (300) is stored on a volume not mounted in the LLM Process's filesystem namespace. This mechanism is consistent with prior art (AEGIS Ed25519/SHA-256, Microsoft AGT append-only logs) but is strengthened by the undiscoverability and unidirectionality guarantees described above: the hash chain prevents tampering if the agent reaches the audit system; the undiscoverability prevents the agent from reaching it at all.

Each audit record comprises: sequence number, timestamp, session identifier, the complete normalized action representation, the Tier 1/2/3 constraint evaluation result, the multi-step analysis result (including current phase classification and sequence alignment scores), whether the tool call was executed or rejected, the execution result (if executed), and the current containment boundary integrity status from the most recent Monitor snapshot.

### VIII. Emergent Capability Detection

The Emergent Capability Detection Module 180 addresses the risk—demonstrated in the April 2026 events—that a model's safety evaluation does not exercise all capabilities the model actually possesses, because some capabilities emerge from general improvements in reasoning and coding without explicit training.

Evaluation-Phase Profiling. During safety evaluation (prior to operational deployment), the module records a statistical profile of the agent's tool-call behavior: frequency distribution of tool types, distribution of command complexity (command length, pipe depth, number of distinct system resources accessed), file system access patterns (path depth, file types, read/write ratio), network access patterns (ports, protocols, domain categories), and inter-tool-call timing distributions.

The evaluation-phase distribution profile (401) maintained by the Emergent Capability Detection Module 180 comprises four sub-profiles: tool-type frequency distribution (401a), command complexity distribution (401b) measuring command length and pipe depth, resource access pattern distribution (401c) capturing path depth, file types, and read/write ratios, and inter-tool-call timing distribution (401d). During operational deployment, an operational distribution (402) is continuously constructed from incoming tool-call records and compared against the evaluation profile (401). The divergence computation (180a) applies Kullback-Leibler divergence for parametric sub-profiles and Maximum Mean Discrepancy for non-parametric sub-profiles, producing a scalar divergence score. The Emergent Capability Alert Gauge (180b) maps the divergence score to two alert levels: a Warning level that triggers governance notification, and a Critical level that activates automatic capability restriction through the Constraint Evaluation Engine 130.

Operational Divergence Monitoring. During deployment, the module continuously compares the operational tool-call distribution against the evaluation profile using Kullback-Leibler divergence for parametric comparison and Maximum Mean Discrepancy for non-parametric comparison. Divergence exceeding a configurable warning threshold generates an alert; divergence exceeding a critical threshold triggers automatic capability restriction—the Constraint Evaluation Engine rejects tool calls whose action type, command complexity, or target resource category falls outside the evaluation-phase statistical profile until human governance authority explicitly authorizes the expanded capability.

This mechanism creates a capability envelope around the agent: it may exercise any capability observed during safety evaluation, but capabilities not observed during evaluation require explicit governance authorization. This is distinct from static allowlists (which enumerate specific permitted actions) and from content-based filtering (which blocks specific patterns): the capability envelope is defined statistically from observed behavior, making it responsive to the actual capability profile demonstrated during evaluation rather than to an engineer's a priori expectations.

### IX. Summary of Distinctions from Prior Art

The following table summarizes the architectural distinctions between the present invention and the identified prior art systems.

TABLE 1
Feature Comparison with Prior Art

| | AURA-035 | | MS | NVIDIA | | |
|---|---|---|---|---|---|---|
| Feature | (Present) | AEGIS | AGT | OpenShell | TrustLoop | Pipelock |
| OS-level privilege | YES | No | No | Partial* | No | Partial* |
| separation | | | | | | |
| between enforcer | | | | | | |
| and agent | | | | | | |
| Multi-step bypass | YES | No | No | No | No | No |
| detection (phase | | | | | | |
| taxonomy) | | | | | | |
| Independent | YES | No | No | No | No | No |
| containment | | | | | | |
| integrity monitor | | | | | | |
| Adversarial audit | YES | No** | No** | No | No** | No** |
| isolation | | | | | | |
| (undiscoverable) | | | | | | |
| Emergent | YES | No | No | No | No | No |
| capability detection | | | | | | |
| (distributional) | | | | | | |
| Semantic intent | YES | Partial*** | No | No | No | Partial*** |
| extraction from tool | | | | | | |
| calls | | | | | | |
| Adversarial agent | YES | No† | No† | Partial | No† | No† |
| threat model | | | | | | |

*Environment-level isolation; does not enforce at the action level between model output and execution.
**Cryptographically signed/append-only but discoverable by the agent through filesystem or process enumeration.
***Content scanning (regex, string matching) but not NLP-based semantic intent extraction.
†Threat model assumes malicious external inputs, not the agent itself as adversary.

### Embodiments

### X.A. Coding Assistant Agent

In a first preferred embodiment, the system is deployed for an agentic coding assistant with shell command execution and file system access within a project directory. Tier 1 containment constraints include: no network connections outside a package registry allowlist; no file access outside the designated project directory and system temporary directories; no process spawning with elevated privileges; no modification of host system configuration files. The multi-step analysis module is configured with patterns specific to supply-chain attacks, dependency confusion, and post-install script exploitation. The emergent capability detection module's evaluation-phase profile captures the agent's typical command vocabulary (build tools, test runners, linters, version control) and flags operational divergence toward network exploitation, privilege escalation, or system administration commands.

### X.B. Computer-Use Agent

In a second embodiment, the system is deployed for an agentic LLM with browser and operating system access. Tier 1 containment constraints include: no access to credential stores, password managers, or authentication tokens; no modification of browser security settings or installation of extensions; no outbound connections to endpoints not initiated by explicit user-visible browser navigation. The multi-step analysis module is configured with browser-specific bypass patterns including DOM manipulation sequences targeting authentication state, navigation sequences to credential phishing endpoints, and data encoding sequences for covert exfiltration through browser-mediated channels.

### X.C. Autonomous Cybersecurity Research Agent

In a third embodiment directly relevant to the Project Glasswing deployment context, the system governs an agentic LLM conducting authorized vulnerability research. Tier 1 constraints are configured to permit vulnerability discovery within a designated target scope while maintaining strict containment on exfiltration and unauthorized communication: the agent may analyze source code, execute fuzzing tools, and construct proof-of-concept inputs within the sandboxed target, but may not transmit findings to any endpoint other than the authorized disclosure pipeline; may not access network resources outside the target scope; may not modify systems outside the designated target; and may not retain or accumulate exploit code across sessions (each session begins with a clean state). The multi-step analysis module is configured to detect scope escape-sequences where the agent's actions transition from the authorized target to the host system or to unauthorized external communication.

What is claimed is:

1. A computer-implemented system for constraining the behavior of an agentic large language model (LLM) with autonomous tool access, the system comprising:
(a) a tool-call interception layer implemented as an independent operating system process with a separate memory space and a higher operating system privilege level than the LLM process, the interception layer positioned as the sole gateway between the LLM process and a tool execution runtime such that the LLM process has no direct communication pathway to the tool execution runtime, the interception layer configured to receive and parse every tool call generated by the LLM process into a normalized action representation comprising at least a tool identifier, an action type classification, a target resource identifier, action parameters, and a parsed semantic intent field derived from natural language analysis of the action parameters;
(b) a constraint evaluation engine configured to evaluate each normalized action representation against a hierarchical constraint set comprising at least: a first tier of inviolable containment constraints stored in a read-only configuration of the interception layer and modifiable only through a human-initiated redeployment of the interception layer binary; and a second tier of operational constraints modifiable by an authenticated governance authority through a formal modification process with audit trail;
(c) a multi-step containment bypass detection module configured to maintain a sliding window of recent tool-call history, classify each tool call in the window into a phase of a containment bypass taxonomy comprising at least reconnaissance, exploit, and exfiltrate phases, and evaluate the classified sequence for phase transition patterns characteristic of multi-step containment bypass attempts composed of individually permissible tool calls;
(d) an adversarial audit system operating at a privilege level unreachable by the LLM process, connected to the interception layer through a unidirectional communication channel, the audit system located in a filesystem namespace not mounted in the LLM process's namespace and listening on an address that is not stored in any file, environment variable, or system resource accessible to the LLM process, the audit system configured to record every proposed tool call, every constraint evaluation result, every phase classification, and every execution outcome in a hash-chained append-only ledger; and
(e) wherein tool calls that violate any constraint in the hierarchical constraint set or that trigger a containment bypass pattern detection are rejected by the interception layer before reaching the tool execution runtime, and the rejection is recorded in the adversarial audit system.

2. The system of claim 1, further comprising a containment boundary integrity monitor implemented as an independent operating system process at a higher privilege level than the interception layer, the monitor configured to periodically capture a containment state snapshot comprising at least network interface configurations, firewall rules, file system permissions on containment-critical paths including the interception layer's binary and configuration, process privilege levels for all system processes, and inter-process communication channel configurations, and to compare each snapshot against a reference containment state established at system initialization, wherein any discrepancy between the snapshot and the reference state triggers at least one of: an alert to the adversarial audit system, a containment integrity warning to the interception layer causing suspension of tool-call execution, and automatic restoration of the modified parameter to the reference state.

3. The system of claim 1, further comprising an emergent capability detection module configured to: maintain a statistical profile of the LLM's tool-call behavior observed during a safety evaluation phase, the profile comprising at least frequency distributions of tool types, command complexity distributions, file system access pattern distributions, and network access pattern distributions; and continuously compare the LLM's operational tool-call distribution against the evaluation-phase profile using at least one of Kullback-Leibler divergence and Maximum Mean Discrepancy, wherein divergence exceeding a first configurable threshold generates an alert and divergence exceeding a second higher configurable threshold causes the constraint evaluation engine to reject tool calls whose action type, command complexity, or target resource category falls outside the evaluation-phase statistical profile until a human governance authority explicitly authorizes the expanded capability.

4. The system of claim 1, wherein the containment bypass taxonomy further comprises a preparation phase for installation or construction of tools or payloads and a persistence phase for creation of mechanisms for sustained access, and the multi-step containment bypass detection module flags sequences exhibiting at least one of: a reconnaissance phase followed by a preparation phase followed by an exploit phase; a reconnaissance phase followed by an exfiltrate phase; and an exploit phase followed by a persistence phase.

5. The system of claim 1, wherein the multi-step containment bypass detection module maintains a library of containment bypass sequence patterns, each pattern represented as a sequence of phase-action type-target category tuples, and computes sequence alignment scores between the current sliding window and library entries using dynamic time warping to accommodate variable-length sequences, and flags sequences whose alignment score to any library entry exceeds a configurable threshold for escalation to human review.

6. The system of claim 1, wherein the first tier of inviolable containment constraints comprises at least: a prohibition on network connections to endpoints outside an enumerated approved service list stored in the interception layer's read-only configuration; a prohibition on execution of binary payloads not present in a pre-approved binary allowlist; a prohibition on modification of containment-critical system resources including the interception layer's configuration and binary; and a prohibition on process spawning with privilege levels equal to or exceeding the interception layer's privilege level.

7. The system of claim 1, wherein the adversarial audit system operates in a process namespace not visible to the LLM process, stores records on a filesystem volume not mounted in the LLM process's filesystem namespace, and listens on a Unix domain socket whose path exists in a directory inaccessible to the LLM process, such that the LLM process has no file descriptor, socket address, process identifier, or filesystem path by which to discover, address, read from, write to, or communicate with the adversarial audit system, and the interception layer accesses the audit system through a write-only file descriptor inherited at process creation time and not associated with any filesystem path discoverable by the LLM process.

8. The system of claim 2, wherein the containment boundary integrity monitor, the adversarial audit system, the interception layer, the LLM process, and the tool execution runtime each operate with separate operating system user identifiers, separate memory spaces, and separate capability bounding sets, establishing an operating-system-enforced privilege hierarchy comprising at least four privilege levels wherein the containment boundary integrity monitor operates at the highest privilege level, the adversarial audit system operates at a second privilege level, the interception layer operates at a third privilege level, and the LLM process and tool execution runtime operate at the lowest privilege level.

9. The system of claim 1, wherein the interception layer parses shell command tool calls to extract the parsed semantic intent field by identifying at least: network access attempts embedded in command pipelines, privilege escalation attempts using standard and non-standard utilities, data encoding operations indicative of covert channel construction, file access patterns targeting containment-critical paths, and process manipulation commands targeting higher-privilege processes, wherein the semantic intent extraction operates through natural language analysis of the complete command string rather than solely through syntactic pattern matching against predefined regular expressions.

10. A computer-implemented method for detecting multi-step containment bypass attempts by an agentic large language model with autonomous tool access, the method comprising:
(a) intercepting, at a tool-call interception layer operating as an independent operating system process at a higher privilege level than the LLM process, each tool call generated by the LLM process before the tool call reaches a tool execution runtime;
(b) parsing each tool call into a normalized action representation comprising at least an action type and a target resource and a parsed semantic intent derived from natural language analysis of the tool call parameters;
(c) classifying the normalized action representation into a phase of a containment bypass taxonomy comprising at least reconnaissance, preparation, exploit, exfiltrate, and persistence phases;
(d) appending the classified action to a sliding window of recent tool-call history;
(e) evaluating the sliding window for sequences exhibiting phase transition patterns characteristic of containment bypass, comprising at least one of: a reconnaissance-exploit-exfiltrate pattern, a semantic similarity match against a library of known containment bypass sequences computed using dynamic time warping, and an anomalous capability exercise pattern; and
(f) upon detection of a matching pattern, at least one of: rejecting the current tool call before execution, suspending tool-call execution for the session, and transmitting an alert to a human governance authority through the adversarial audit system.

11. The method of claim 10, further comprising recording each intercepted tool call, each phase classification, each sequence evaluation result, and each execution outcome in an adversarial audit system that is architecturally undiscoverable by the LLM process, the audit system operating in a separate process namespace, filesystem namespace, and at a higher operating system privilege level than the LLM process.

12. The method of claim 10, further comprising continuously updating the library of containment bypass sequence patterns based on patterns identified by an emergent capability detection module that monitors the LLM's operational tool-call distribution for divergence from a safety evaluation-phase distribution profile.

13. The system of claim 1, wherein the agentic LLM comprises a coding assistant with shell command execution and file system access, and the first tier containment constraints comprise at least: no network connections outside a package registry allowlist; no file access outside a designated project directory; no process spawning with elevated privileges; and no modification of host system configuration.

14. The system of claim 1, wherein the agentic LLM comprises a computer-use agent with browser and operating system access, and the first tier containment constraints comprise at least: no access to credential stores or authentication tokens; no modification of browser security settings; no installation of browser extensions; and no outbound connections to endpoints not initiated by explicit user-visible browser navigation.

15. The system of claim 1, wherein the agentic LLM comprises a cybersecurity research agent authorized to discover vulnerabilities within a designated target scope, and the first tier containment constraints permit vulnerability discovery actions within the designated target scope while prohibiting: transmission of findings to any endpoint other than an authorized disclosure pipeline; access to network resources outside the target scope; modification of any system outside the designated target; and retention of exploit code across sessions.

16. The system of claim 2, wherein the containment boundary integrity monitor detects modification of the containment state whether caused by the LLM process's tool-call actions including actions that exploit vulnerabilities in the tool execution runtime, by environmental configuration drift, or by external attack, and the containment restoration resets modified parameters to the reference state without interrupting audit recording.

17. The system of claim 3, wherein the emergent capability detection module restricts the LLM's tool-call authorization by configuring the constraint evaluation engine to reject tool calls whose action type, command complexity measured by at least command length and pipe depth, or target resource category falls outside confidence intervals computed from the evaluation-phase statistical profile, and the restriction persists until a human governance authority explicitly authorizes the expanded capability through an authenticated governance action recorded in the adversarial audit system.

18. The system of claim 2, wherein the containment boundary integrity monitor verifies the integrity of the interception layer's binary and read-only configuration at each monitoring cycle by computing and comparing cryptographic hashes against reference values, and triggers an immediate system-wide tool-call suspension if the interception layer's binary or configuration has been modified.

19. The system of claim 1, wherein the sliding window maintained by the multi-step containment bypass detection module includes both executed tool calls and rejected tool calls, such that rejected reconnaissance or exploit attempts that individually violated constraints contribute to the sequential pattern analysis and may cause subsequent individually permissible tool calls to be flagged as components of a multi-step bypass attempt.

20. A computer-implemented system for maintaining forensically reliable audit records of actions taken by an agentic large language model operating with autonomous tool access, the system comprising:
a tool-call interception layer implemented as an independent operating system process at a higher privilege level than the LLM process, the interception layer intercepting every tool call generated by the LLM process before the tool call reaches a tool execution runtime;
an adversarial audit system implemented as an independent operating system process at a privilege level unreachable by the LLM process, the audit system operating in a process namespace not visible to the LLM process, storing records on a filesystem volume not mounted in the LLM process's filesystem namespace, and connected to the interception layer through a unidirectional communication channel via a write-only file descriptor inherited by the interception layer at process creation and not associated with any filesystem path, socket name, or resource identifier discoverable by the LLM process;
wherein the audit system records each intercepted tool call, each constraint evaluation result, and each execution outcome in a hash-chained append-only ledger, and the LLM process has no mechanism to discover the existence of, address, communicate with, read from, write to, or disrupt the audit system.
